(19) United States
(12) Patent Application Publication
(10) Pub. No.: US 2015/0189383 A1
(43) Pub. Date: Jul. 2, 2015

(54) Display Apparatus, Method, and Storage Medium

(71) Applicants: Kabushiki Kaisha Toshiba, Tokyo (JP); Toshiba Lifestyle Products & Services Corporation, Tokyo (JP)

(72) Inventor: Miki Saijo, Akishima (JP)

(21) Appl. No.: 14/463,473

(22) Filed: Aug. 19, 2014

Related U.S. Application Data
(60) Provisional application No. 61/921,035, filed on Dec. 26, 2013.

(51) Int. Cl. H04N 21/466; H04N 21/45; H04N 21/643; H04N 21/482; H04N 21/472; H04N 21/442; H04N 21/462

(52) U.S. Cl. CPC H04N 21/4668; H04N 21/44204; H04N 21/44222; H04N 21/4532; H04N 21/462; H04N 21/4667; H04N 21/4826; H04N 21/4821; H04N 21/47205; H04N 21/64322

(57) ABSTRACT

According to one embodiment, a display apparatus includes a controller configured to display information relating to a content with the longest viewing time within a past predetermined time period.

### CROSS-REFERENCE TO RELATED APPLICATIONS

This application claims the benefit of U.S. Provisional Application No. 61/921,035, filed Dec. 26, 2013, the entire contents of which are incorporated herein by reference.

### FIELD

Embodiments described herein relate generally to a display apparatus, a method, and a storage medium.

### BACKGROUND

Recently, because the number of channels television sets can receive has greatly increased, users may have trouble finding a channel carrying a program they want to watch. While it may be relatively easy for a user to find a suitable channel when the television set has an internal tuner alone, it may often be very difficult to do so when an external video source is further connected to an external input of the television set.

Regarding current television sets, which have multiple channels, users may have trouble finding a channel carrying a program they want to watch.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is a block diagram illustrating an exemplified circuit structure of an image display apparatus according to an embodiment.

FIG. 2 is a plan view illustrating an exemplified key arrangement for a remote controller of the image display apparatus according to the embodiment.

FIG. 3 illustrates exemplified changes in the state of a flip bar menu display according to the embodiment.

FIG. 4 illustrates an exemplified Last Week menu display according to the embodiment.

FIG. 5 illustrates another exemplified Last Week menu display according to the embodiment.

FIG. 6 is a flowchart illustrating exemplified Initial Settings according to the embodiment.

FIG. 7 illustrates an exemplified Reference Channel Settings screen according to the initial settings.

FIG. 8 is a flowchart illustrating an example of how to set Favorite Channels according to the flow of the initial settings.

FIG. 9 illustrates an exemplified Favorite Channels setting screen for the internal tuner according to the flowchart of FIG. 8.

FIG. 10 illustrates an exemplified Favorite Channels setting screen for the external input in the flowchart of FIG. 8.

FIG. 11 is a flowchart illustrating an example of TV settings according to the embodiment.

FIG. 12 is a flowchart illustrating an exemplified remote control operation according to the embodiment.

FIG. 13 is a flowchart illustrating how the exemplified Last Week menu is displayed according to the embodiment.

FIG. 14 illustrates an exemplified screen for prompting a user to select the Reference Channel according to the flowchart of FIG. 13.

FIG. 15 illustrates an exemplified screen prompting a user to connect to the Internet according to the flowchart of FIG. 13.

FIG. 16 illustrates an exemplified data structure of a viewing history according to the embodiment.

### DETAILED DESCRIPTION

Various embodiments will be described hereinafter with reference to the accompanying drawings.

In general, according to an embodiment, a display apparatus includes a controller configured to display information relating to a content with the longest viewing time within a past predetermined time period.

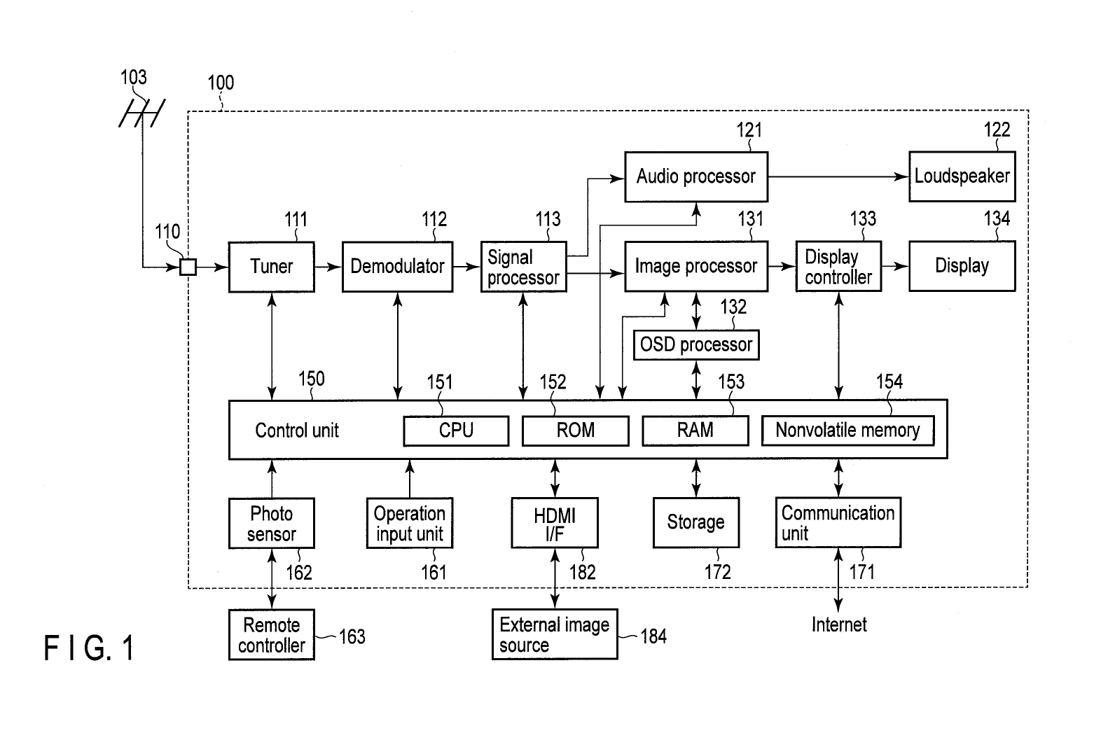

FIG. 1 illustrates an exemplified structure of an image display apparatus 100 according to an embodiment. The image display apparatus 100 may be, for instance, a display capable of displaying image content from a broadcast signal, or reproducing image content stored in a storage medium or distributed through the Internet. The image display apparatus 100 may be, for instance, a display for a television set, a recorder, a tuner, a PC equipped with a program for reproducing content distributed through any networks, or a portable telephone terminal such as a mobile phone equipped with a tuner. The image display apparatus 100 may be capable of connecting to the Internet through a wireless communication terminal functioning as a wireless access point.

The image display apparatus 100 may include, for instance, a broadcast signal input terminal 110, a tuner 111, a demodulator 112, a signal processor 113, an audio processor 121, an image processor 131, an OSD processor 132, a display controller 133, a control unit 150, an operation input unit 161, a photosensor 162, a communication unit 171, a storage 172, an HDMI interface 182, etc. Furthermore, the image display apparatus 100 may have a loudspeaker 122 and a display 134.

The broadcast signal input terminal 110 is capable of receiving a digital broadcast signal, which an antenna 103 receives. The antenna 103 is capable of receiving a terrestrial digital broadcast signal, a Broadcasting Satellite (BS) digital broadcast signal, and/or a 110 degrees Communication Satellite (CS) digital broadcast signal. The broadcast signal input terminal 110 is capable of receiving content data such as a program supplied from any of the above-mentioned digital broadcast signals.

The broadcast signal input terminal 110 supplies the received digital broadcast signal to the tuner 111. The tuner 111 is a tuner for digital broadcast signals. The tuner 111 supplies the tuned digital broadcast signal to the demodulator 112.

The demodulator 112 demodulates the received digital broadcast signal. The demodulator 112 thereby obtains content data, such as a transport stream, from the digital broadcast signal. The demodulator 112 inputs the obtained content data to the signal processor 113. Namely, the antenna 103, the tuner 111 and the demodulator 112 cooperate to function as a receiving unit for receiving content data.

The signal processor 113 performs signal processing such as separation of content data. Namely, the signal processor 113 separates the content data into a digital image signal, a digital audio signal, and the other data signals. The signal processor 113 supplies the audio signal to the audio processor 121, the image signal to the image processor 131, and the data signals to the control unit 150.

The audio processor 121 converts the digital audio signal having been received from the signal processor 113 to a signal in a format that allows the loudspeaker 122 to convert the signal into sound (an audio signal). The audio processor 121 converts the digital audio signal to an analogue audio signal through digital-to-analogue conversion. The audio processor 121 supplies the analogue audio signal to the loudspeaker 122. The loudspeaker 122 produces sounds according to the supplied analogue audio signal.

The image processor 131 converts the digital image signal having been received from the signal processor 113 to an image signal in a format that allows the display 134 to display an image on the screen (a display image signal). The image processor 131 performs a rendering, which generates the display image signal according to the digital image signal having been supplied from the signal processor 113. The image processor 131 performs the rendering by subjecting to various operations the digital image signal having been supplied from the signal processor 113. The image processor 131 outputs the rendered display image signal to the display controller 133.

The OSD processor 132 generates display image signals, which cause the display 134 to display various items of information through a menu screen, a channel list, an electronic program guide (EPG), a browser for reading websites, windows for various applications, a setup menu, a flip bar menu (See below for further details.), etc., in accordance with commands supplied from the control unit 150. The OSD processor 132 superposes the images provided by the generated display image signal onto the image provided by the display image signal output from the image processor 131.

The display controller 133 performs an image quality adjustment concerning hue, brightness, sharpness, contrast, etc., with respect to the received image signal under the control of the control unit 150. The display controller 133 supplies to the display 134 the display image signal having been adjusted in image quality. The display 134 displays an image according to the supplied display image signal.

The display 134 may include, for instance, a liquid crystal display unit equipped with a liquid crystal display panel and a backlight for lighting up the liquid crystal display panel. The liquid crystal display panel has matrically arranged pixels. The display 134 displays the image according to the display image signal supplied from the display controller 133.

The control unit 150 functions as a control unit for controlling the operation of every unit of the image display apparatus 100. The control unit 150 may include a CPU 151, a ROM 152, a RAM 153, a nonvolatile memory 154, etc. The control unit 150 performs various operations according to the operation signals supplied from the operation input unit 161 or the photosensor 162.

The CPU 151 may include operation elements for executing various operations. The CPU 151 implements various functions by executing any program stored in the ROM 152 or the nonvolatile memory 154.

The ROM 152 stores programs for controlling the image display apparatus 100 and programs for implementing various functions. The CPU 151 activates a program, which is stored in the ROM 152, according to the operation signal supplied from the operation input unit 161. The control unit 150 thereby controls the operation of every unit. The program has a function of causing a flip bar menu to be displayed on the screen according to the operation of flip bar keys in a remote controller.

The RAM 153 functions as a working memory for the CPU 151. Namely, the RAM 153 stores the operation results of the CPU 151, data having been read into the CPU 151, etc.

The nonvolatile memory 154 stores programs and information on various settings.

The control unit 150 selects a broadcast signal according to the input operation of the user. The control unit 150 selects a program which the image display apparatus 100 should display (or a channel which provides the program) according to the input operation of the user.

The control unit 150 generates commands for causing the display 134 to display various user interfaces, including the flip bar menu. The control unit 150 supplies the generated commands to the OSD processor 132. In this way, the control unit 150 causes the OSD processor 132 to generate any user interfaces to be superposed on the image displayed on the screen.

The operation input unit 161 may include operation keys, or a touch pad, for generating any operation signal according to the input operation of the user. It may be possible for the operation input unit 161 to have a structure that receives operation signals from a key board, a mouse, or any other input device that is capable of generating the operation signals. The operation input unit 161 supplies the operation signals to the control unit 150. The touch pad includes a capacitive sensor or a device which generates positional information according to another method.

The photosensor 162 may includes, for instance, a light receiving lens for receiving infrared rays from the remote controller 163 and a sensor such as a photodiode for converting the rays into electric signals. The photosensor 162 generates original operation signals from the received infrared rays, and supplies the operation signals to the control unit 150.

The remote controller 163 generates an operation signal according to the input operation of the user. The remote controller 163 converts the generated operation signal into an infrared ray, and outputs the infrared ray. The remote controller 163 thereby transmits the infrared ray to the photosensor 162.

The communication unit 171 can communicate with another device in a network, such as the Internet or a home network, through a wireless communication unit connected to a LAN or a wireless LAN. The image display apparatus 100 can thereby communicate with another device connected to a wireless communication unit.

The storage 172 may include a hard disk drive (HDD), a solid-state drive (SSD), or another memory unit. The control unit 150 is capable of causing the storage 172 to store a transport stream having been processed by the signal processor 113. Furthermore, the control unit 150 is capable of encoding the transport stream into data in another format. It is possible for the control unit 150 to have a structure that causes the storage 172 to store the encoded data. In such a case, the image display apparatus 100 is capable of recording in the storage 172 a broadcast signal or content having been supplied through the network, or replaying the recorded content from the storage 172.

The control unit 150 is connected through the HDMI interface 182 to an external image source 184. The external image source 184 may include an external HDD, an SSD, or a cable television set-top box, for instance.

The image display apparatus 100 may include plural sets of the tuner 111 and the demodulator 112. The image display apparatus 100 having plural sets of the tuner 111 and the demodulator 112 can extract plural broadcast signals with different frequencies. The image display apparatus 100 can thereby obtain a plurality of transport streams from a plurality of channels at the same time. The image display apparatus 100 can thereby cause the storage 172 to store the plurality of transport streams of the plurality of channels or the data obtained by encoding the transport streams.

The communication unit 171 may receive signals from a key board, a mouse, a microphone, a headset, or any other input device. For instance, in a case where the image display apparatus 100 is equipped with a USB terminal or a module for Bluetooth (a registered trademark), the communication unit 171 receives any signal from any input device that is connected to the image display apparatus 100 through USB or Bluetooth, and sends the signal to the control unit 150.

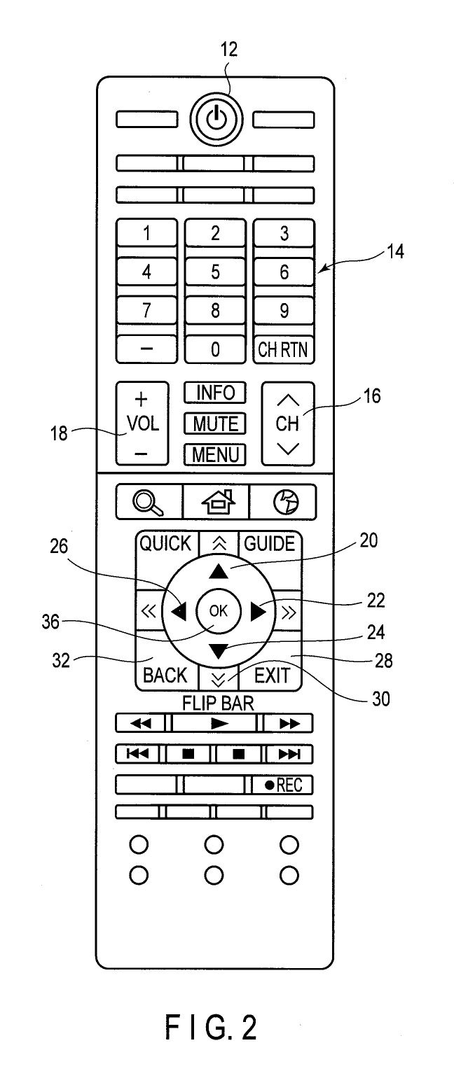

FIG. 2 is a plan view illustrating an exemplified key arrangement for the remote controller 163 of the image display apparatus in the embodiment. A power key 12 is arranged at the upper middle portion. Around the power key 12, there are arranged several keys for allowing the user to select various content sources. Under the power key 12, there are arranged numeric keys 14, each bearing one of 0 to 9, for allowing the user to specify a desired channel. Under the numeric keys 14, a channel increase/decrease key 16 and a volume increase/decrease key 18 are respectively arranged at the right and the left. Furthermore, a multi-key is provided under the channel increase/decrease key 16 and the volume increase/decrease key 18. The multi-key can be pressed at the right position, the left position, the top position, the bottom position, or one of the four oblique positions. The multi-key functions as an exit key 28 when it is pressed at the obliquely right bottom position, as a flip bar key 30 when it is pressed at the middle bottom position, and as a back key 32 when it is pressed at the obliquely left bottom position. It should be noted that the multi-key functions as the flip bar key 30 only when it is pressed at the middle bottom position while no GUI element including a menu is displayed on the screen. The multi-key functions as a down key when it is pressed at the middle bottom position while any GUI element including the menu is displayed on the screen. When the exit key 28 or the back key 32 is pressed while the flip bar menu is displayed, the flip bar menu display will turn off.

Within the multi-key, there is provided a directional key which can be pressed at the right position, the left position, the top position, and the bottom position for moving the focus, for instance. The directional key functions as an up key 20 when its upper portion is pressed, a right key 22 when its right portion is pressed, a down key 24 when its bottom portion is pressed, and a left key 26 when its left portion is pressed. At the center of the directional key, there is provided an OK key 36 for making a determination of operation, etc. Under the multi-key, there are provided several operation keys for specifying which operation to be executed among a playback operation, a stop operation, a fast-forward operation, etc.

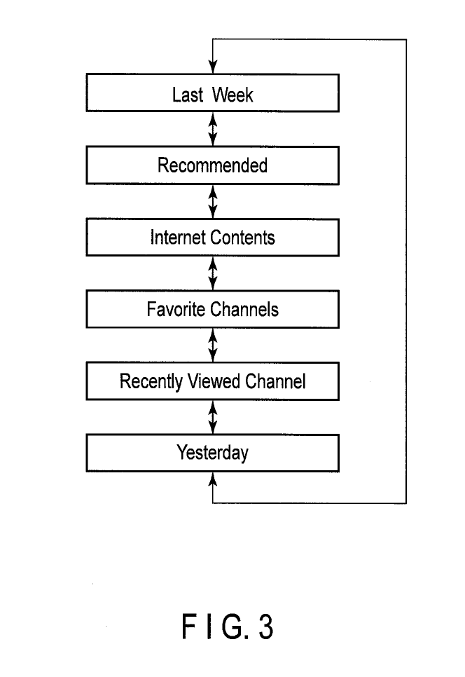

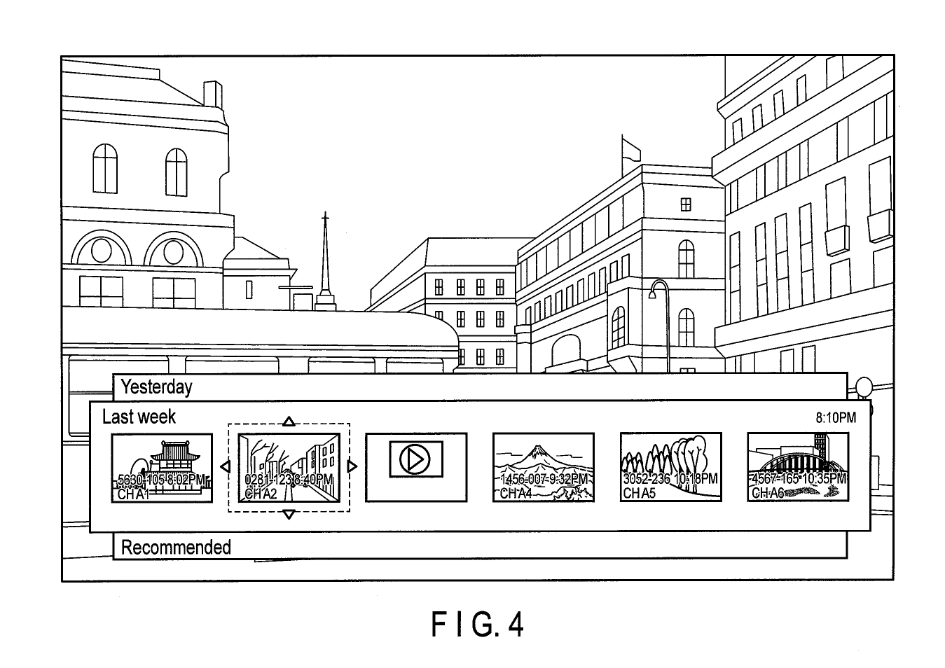

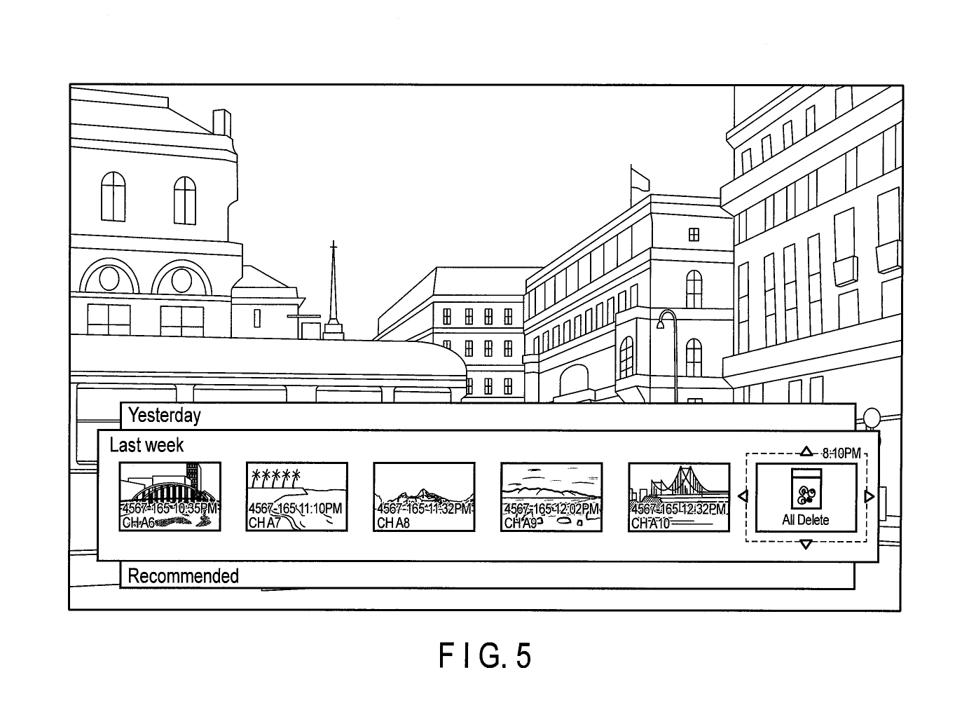

When the flip bar key 30 of the remote controller 163 is pressed while no GUI is displayed on the screen, (namely, while the television picture, the Internet contents, or the played back image, etc., is displayed,) a flip bar menu is displayed at a lower portion of the screen, as illustrated at FIG. 4 or FIG. 5. The flip bar menu includes a total of 6 sub-menus, as illustrated in FIG. 3. Namely, it includes a Last Week menu, a Recommended menu, an Internet Contents menu, a Favorite Channels menu, a Recently Viewed Channel menu, and a Yesterday menu. Any one of the sub-menus is displayed on the screen, whereas the rest sub-menus are concealed behind the displayed one. When the up key 20 or the down key 24 of the remote controller 163 is pressed while one of the sub-menus is displayed on the screen, the focus will move and what is displayed on the screen is changed in turn to another one of the sub-menus as illustrated in FIG. 3 What is displayed on the screen may be changed by adopting a drum roll method, for instance. At a time of shipment from a factory, a predetermined menu such as, for instance, the Favorite Channels menu may be set to be initially displayed. However, it is possible that, at a moment when the display of the flip bar menu turns off, the sub-menu having been just disappeared are held on along with its focused position, and that, when the display of the flip bar menu turns on next time, the sub-menu having been disappeared just before is displayed with putting in focus the same position as before.

The flip bar menu presents the user with thumbnails that represent a predetermined number of content items which the user selected based on what the user was recommended when using the Internet, or a predetermined number of channels which the user selected from the viewing history. Hereinafter the contents and the channels are sometimes collectively referred to as contents. The flip bar menu also presents information about the contents or the channels. The flip bar menu will make it easy for the user to select a content piece which the user wants to watch.

The Recommended menu is a menu that is predicated on the Internet connection. It presents the user with recommended contents information, which is produced by keeping and analyzing the viewing history of the user with the help of the Internet. The Internet Contents menu is also a menu that is predicated on the Internet connection. It presents the user with recommended contents information obtained from animation delivery sites, for instance. The Recently Viewed Channel menu indicates information on the channel the user has viewed recently. The Favorite Channels menu indicates the latest viewing histories of the respective channels, which the user registered in advance.

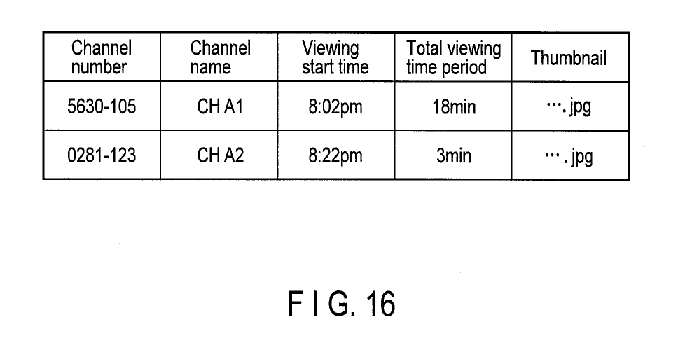

As illustrated in FIG. 4 and FIG. 5, the Yesterday menu and the Last Week menu individually show a viewing history of several hours since the present time of yesterday or the present time of last week (till the time which is closer to the real present time) in the form of a predetermined number of thumbnails (for instance, 10 thumbnails). Each of the thumbnails represents a 30 minutes time period and one of the thumbnails includes the present time of yesterday or the present time of last week. For instance, when the present time is 8:10 p.m., what will be displayed is information about a channel, which provided a program which the user viewed longest of all among the programs broadcasted during each of the total of 10 pieces of 30 minutes time periods (the total of 5 hours), namely, a time period from 8:00 p.m. to 8:30 p.m., that from 8:30 p.m. to 9:00 p.m., that from 9:00 p.m. to 9:30 p.m., that from 9:30 p.m. to 10:00 p.m., that from 10:00 p.m. to 10:30 p.m., that from 10:30 p.m. to 11:00 p.m., that from 11:00 p.m. to 11:30 p.m., that from 11:30 p.m. to 0:00 a.m., that from 0:00 a.m. to 0:30 a.m., and that from 0:30 a.m. to 1:00 a.m. Let us suppose, for instance, that channel A1 (channel number 5630-105) is viewed from 8:00 p.m. to 8:20 p.m., and that channel A2 (channel number 0281-123) is viewed from 8:20 p.m. to 8:25 p.m., as illustrated in FIG. 16, then what will be displayed for a time period from 8:00 p.m. to 8:30 p.m. is information about channel A1 (channel number 5630-105). The channel information includes a channel number, a viewing start time, a channel name, and a thumbnail having the viewing start time. The viewing start time should be a time after a predetermined time, for instance, 2 minutes has passed from a moment when the actual viewing has started. The reason for it is to avoid counting the channels zapped through as viewed. When 2 minutes has passed since the actual viewing started, the time of such a moment is kept as a viewing start time in the viewing history. Furthermore, the image displayed at that moment is captured and used as a thumbnail. It is possible to inhibit the obtainment of a thumbnail from a program, on which a viewing age limit is imposed (or to which the so-called parental lock is set), and to display a No Thumbnail icon, such as illustrated in FIG. 4, as an icon for a time period from 9:00 p.m. to 9:30 p.m.

As will be explained later, externally input channels can be registered with the Favorite Channels menu in the same way as the internal channels in the present embodiment, the image display apparatus 100 can control the externally input channels in the same way as the internal channels. Therefore, what can be displayed as a viewing history in the Yesterday menu or the Last Week menu is not limited to the internal channels alone, but the externally input channels can be also displayed.

The thumbnails that can be displayed at a time are limited to six in number. When the right key 22 or the left key 26 in the remote controller 163 is pressed while the Last Week menu is displayed, as illustrated in FIG. 4, the 6 thumbnails displayed on the screen will change in such a manner that every thumbnail, including concealed thumbnails, rotatively shifts from one position to another. The Yesterday menu or the Last Week menu includes an all-delete icon on the right of the 10th thumbnail, as illustrated in FIG. 5. When the all-delete icon is selected and the OK key 36 is pressed, the viewing history including 10 icons is all deleted.

The Yesterday menu is similar to the Last Week menu. The only difference lies in the fact that the time periods belong to not a week before but a day before. The Recommended menu, the Internet Contents menu, the Favorite Channels menu, the Recently Viewed Channel menu are individually displayed in a similar manner to the Yesterday menu or the Last Week menu. When any one of the thumbnails is selected and the OK key 36 is pressed in whichever menu, the contents related to the selected thumbnail is played back and displayed.

There is a possibility that the contents presented by the Recommended menu, the Internet Contents menu, or the Recently Viewed Channels menu will be renewed to the latest condition while being displayed. However, the renewal of the thumbnails or the contents information will not be executed while the menu in question is being displayed, but the renewal will be deferred to the next time when the menu in question is displayed. This is because it will be hard for the user to see the menu when the menu is renewed while it is being displayed. However, it is possible to perform renewal without being deferred by means of a change in TV settings.

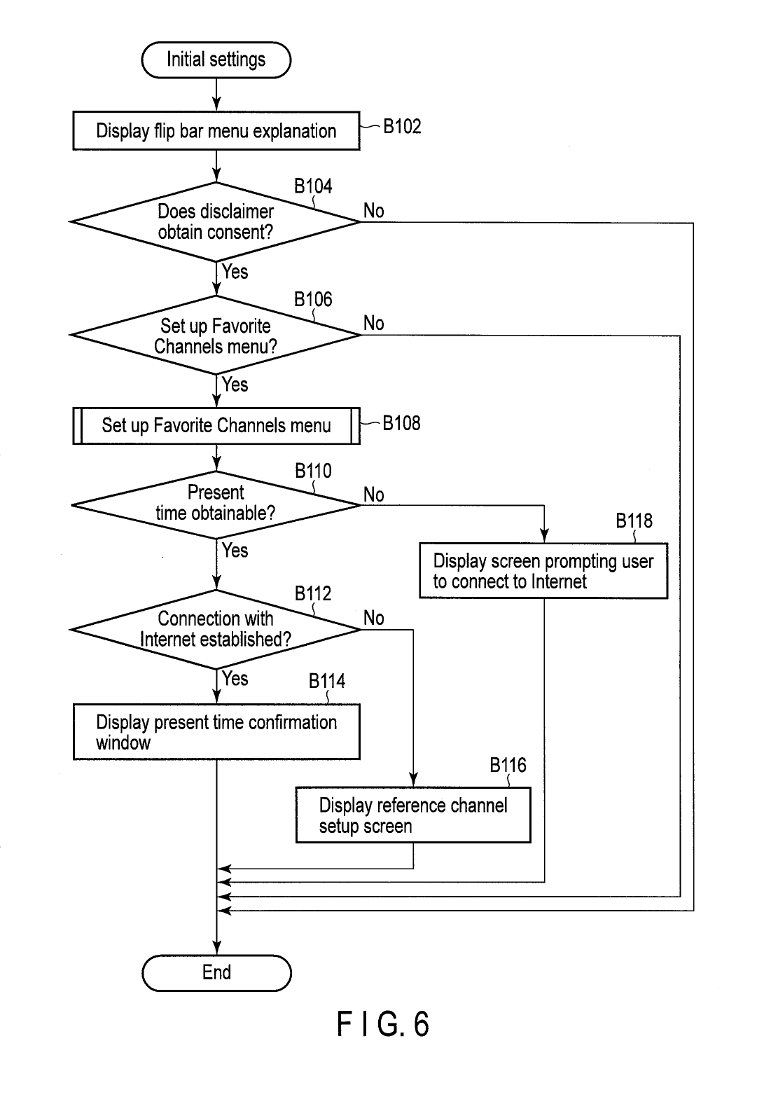

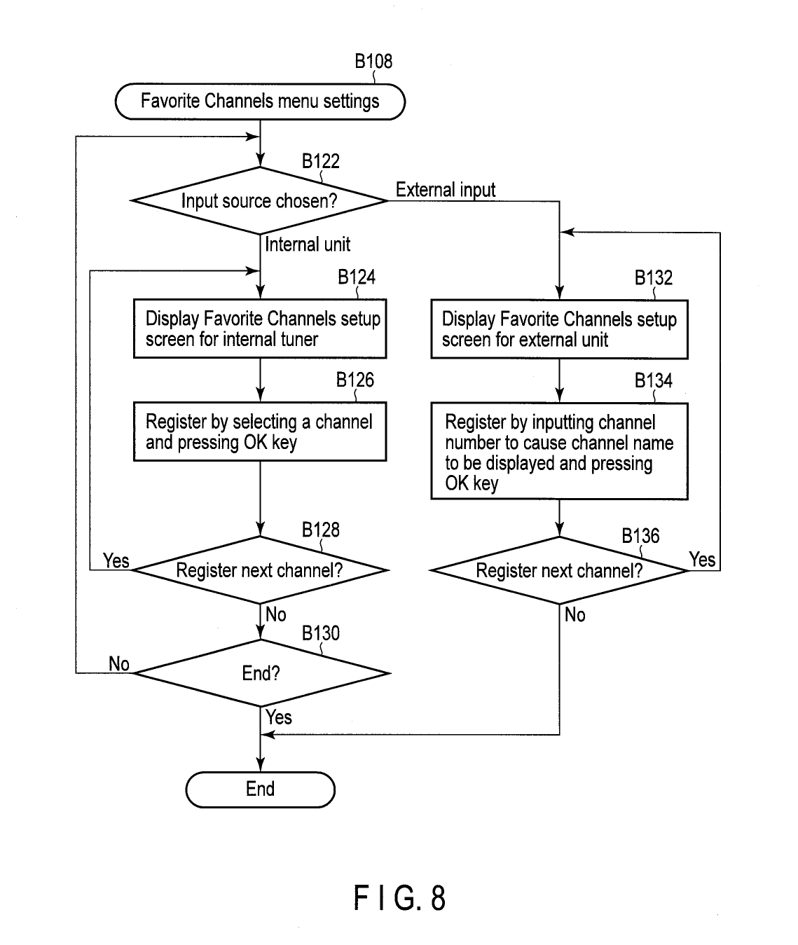

FIG. 6 is a flowchart illustrating exemplified initial settings in the image display apparatus 100. The initial settings are employed when the image display apparatus 100 is used for the first time. In block B102, the explanation of a flip bar menu is displayed. The explanation includes not only the details of functions but also a disclaimer concerning the content of the flip bar menu. In block B104, it is determined whether or not the disclaimer obtains consent. If the disclaimer does not obtain consent, then the flow ends. Only when the disclaimer obtains consent, the user is allowed to use the flip bar menu. In block B106, the user is asked whether the Favorite Channels menu should be set or not. If the user decides not to set the Favorite Channels menu, then the flow ends. Only when the user decides to set the Favorite Channels menu, the Favorite Channels menu is set in block B108. The details of block B108 will be explained later with reference to FIG. 8.

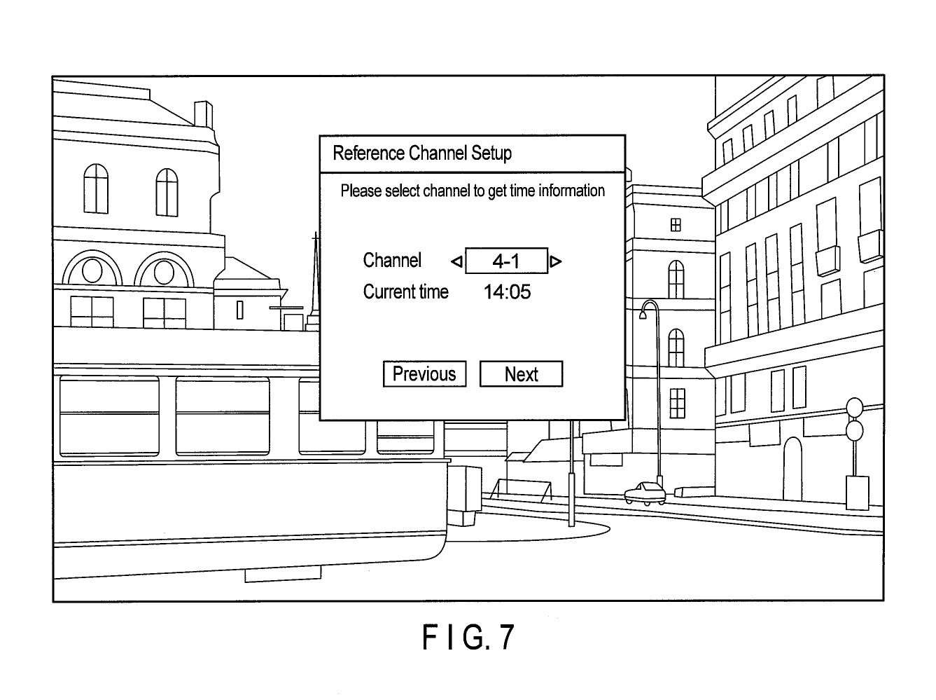

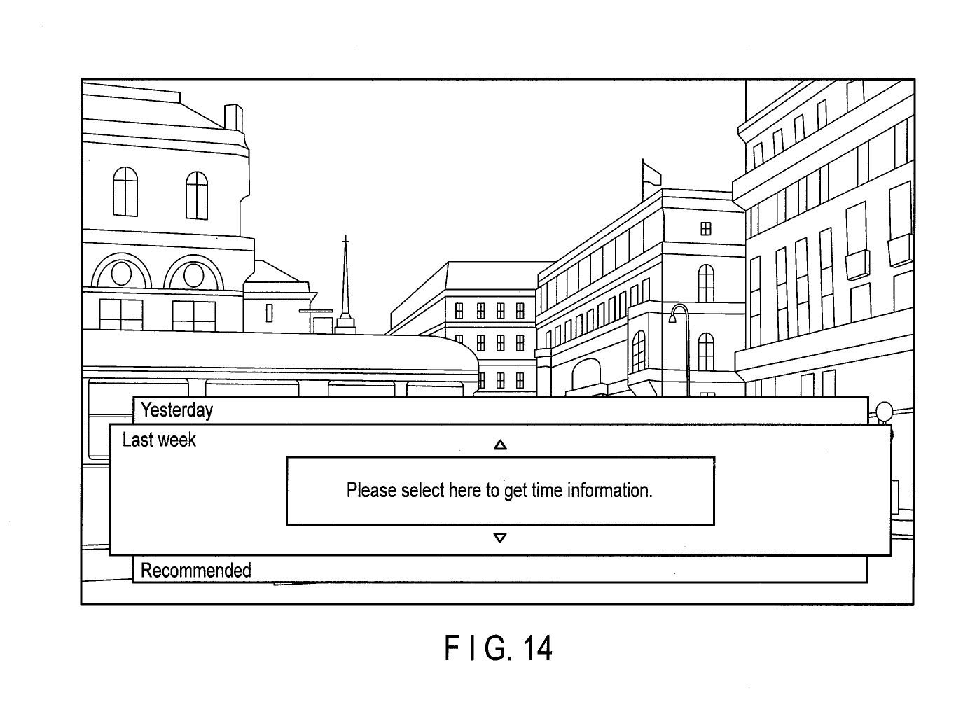

Then, it is determined in block B110 whether or not the present time can be obtained. When it is not possible to obtain the present time, a screen prompting the user to connect to the Internet is displayed in block B118. When it is possible to obtain the present time, it is determined in block B112 whether or not the connection with the Internet is established. When the connection with the Internet is established, the present time obtained from the Internet is displayed for confirmation in block B114. When the connection with the Internet is not established, the reference channel setup screen, such as illustrated in FIG. 7, is displayed in block B116. The reference channel is a channel that shows the time which is the closest to the present time among the times shown by several broadcasting stations. When the connection with the Internet is not established, the user cannot but depend on any one of the broadcasting stations for obtaining the present time. However, since there may be a case in which the present time is not correct in some broadcasting stations, the user must judge which channel shows the correct time. As illustrated in FIG. 7, there appears a time, which is under the control of a broadcasting station that corresponds to a certain channel number. The term “certain channel number” is the channel number of the broadcasting station that is obtained by auto-tuning, namely, one of the initial settings of the television set. When the time shown by the broadcasting station is not adequate, the user click the Next button, or the Previous button, or one of the two triangular buttons, between which there is a display window displaying a channel number “4-1”. Each time the user clicks one of the buttons, the next broadcasting station will appear in place of the displayed one. Then, the user reads the newly displayed time and decides whether the channel providing the newly displayed time should be the reference channel. In a case where the reference channel is not yet set when the power is turned on, a screen prompting the user to set the reference channel is displayed as illustrated in FIG. 14. When the user clicks the icon illustrated in FIG. 14, the television set jumps to the reference channel and obtains the present time.

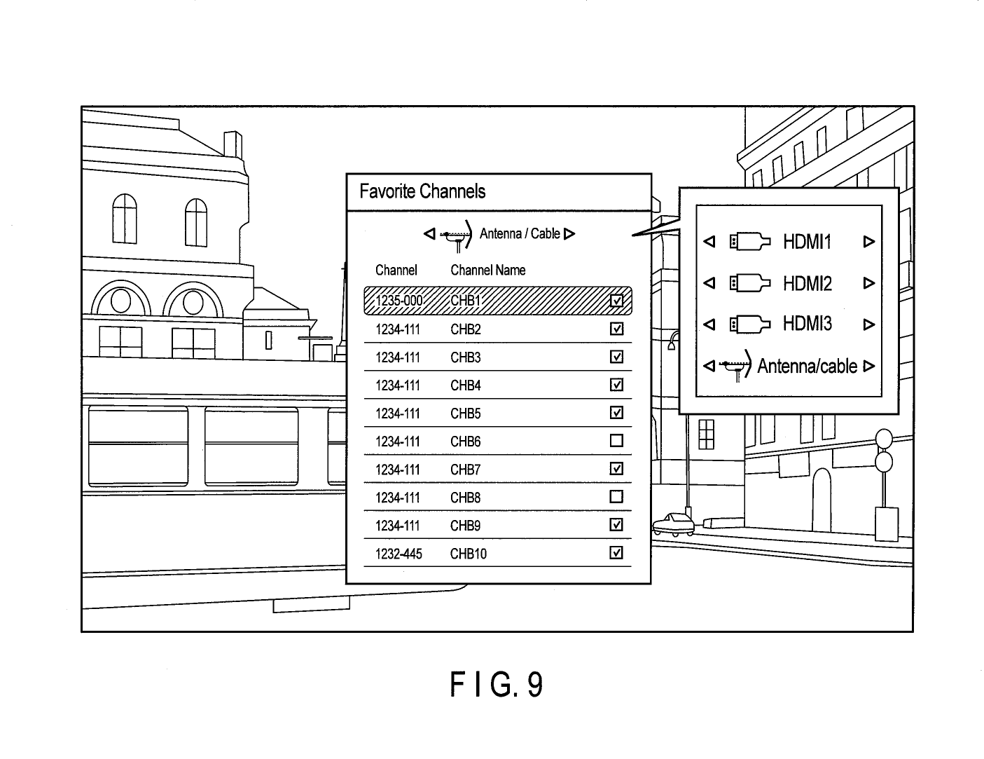

FIG. 8 minutely illustrates an exemplified flowchart of the Favorite Channels setup block B108 in the flowchart of FIG. 6. In block B122, a choice between the two input sources is made. The input sources include an internal unit (antenna/cable) and an external unit (Video1, Video 2, ColorStream HD, HDMI 1, HDMI 2, HDMI 3, and HDMI 4). In the case of the internal unit, the Favorite Channels setup screen for the internal tuner, such as illustrated in FIG. 9, is displayed in block B124. In block B126, the user operates the up key 20 or the down key 24, both on the remote controller 163, to select a channel, and presses the OK key 36. Then, the selected channel is recorded as one of the Favorite Channels. It is determined in block B128 whether a channel registration for an internal tuner should be continued or not, and, in the case where the next channel will be recorded, the flow returns to block B124.

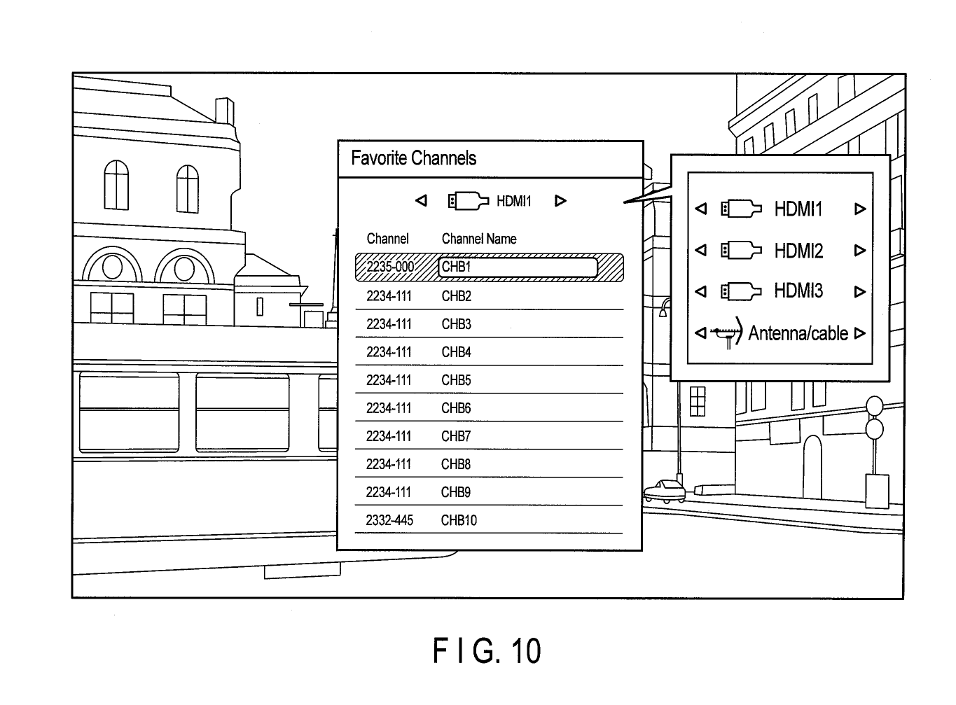

When a further channel registration for a further internal tuner is no longer continued, it is determined in block B130 whether the operation of Favorite Channels registration should be terminated or not. When the registration operation should not be terminated, the flow returns to block B122, and advances to an externally input channel setup operation. In block B132, the Favorite Channels setup screen, such as illustrated in FIG. 10, is displayed for the external unit. The image display apparatus 100 knows the channel number, the channel name, etc., for the internal tuner 111, but does not know any information about the externally input channel. Therefore, it is hitherto impossible to register the externally input channel as one of the Favorite Channels. In contrast, the present embodiment makes it possible to register the externally input channel as will be explained bellow. In block B134, the user operates the up key 20, the down key 24, and the numeric keys 14, all on the remote controller 163, and inputs a channel number into a blank line. The image display apparatus 100 sends the channel number to the external tuner, receives from the external tuner the channel name corresponding to the channel number, and displays the channel name on the screen. Then, the user selects any one of the lines, and presses the OK key 36. The channel in question is registered as one of the Favorite Channels. It is determined in block B136 whether a channel registration for an external tuner should be continued or not, and, in the case where the next channel will be registered, the flow returns to block B132. If Yes is selected in block B130, or if No is selected in block B136, then the flow ends. As having been explained above, the present embodiment assigns a channel number to an external source device even for an externally input channel, and receives therefrom a channel name. As a result, it is possible to execute the Favorite Channels registration. All that should be done to cancel the Favorite Channels registration is to remove a check, which is illustrated in FIG. 9, in the case of an internal tuner, whereas, in the case of an external tuner, to select a channel that corresponds to the tuner, as illustrated in FIG. 10, and to press the predetermined key of the remote controller.

It is possible to register many channels with the Favorite Channels registration. However, the number of channels that the Favorite Channels menu can display is 10. The channels are listed in order of set-up time. The channel that has been registered for the first time is shown at the leftmost end of the flip bar. It should be noted however that, since one or more input sources can be registered, the order in which input sources are shown is as follows (in the order of descending priorities): antenna/cable, Video 1, Video 2, ColorStream HD, HDMI 1, HDMI 2, HDMI 3, and HDMI 4. In a case where many channels are registered as belonging to each of the internal unit and the external unit, the menu will show five channels at the maximum for each unit. In a case where the number of the registered channels is less than five for each unit, then less than ten channels, which is a maximum number of channels that the menu can show at a time, will be shown in the menu. In a case where ten channels are registered as belonging to the internal unit and 30 channels the external unit, the menu will show five channels out of the ten internal channels and five channels out of the 30 external channels. In a case where three channels are registered as belonging to the internal unit and 30 channels the external unit, the menu will show all of the three internal channels and seven channels out of the 30 external channels.

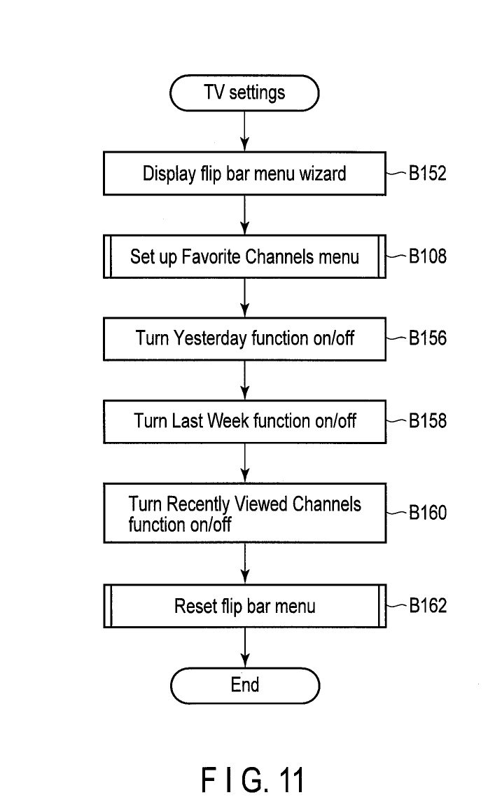

FIG. 11 is a flowchart illustrating an example of the TV settings. Even if the flip bar menu is not set to be usable at the initial settings, the function of setting up the flip bar menu is included in the normal TV setting functions (for making adjustments to images, sounds, etc.), so that the flip bar menu can be later set to be usable. It should be noted that the normal adjustment functions are not illustrated in FIG. 11. In block B152, a flip bar menu wizard is displayed, which allows the user to set various functions such as illustrated in FIG. 6. Although not illustrated in any drawings, let us assume that the user consents to a disclaimer and instructs to set the Favorite Channels menu. The Favorite Channels menu is set in block B108. In block B156, the on/off of the Yesterday function is set. In block B158, the on/off of the Last Week function is set. In block B160, the on/off of the Recently Viewed Channels function is set. The Yesterday menu, the Last Week menu, the Recently Viewed Channels menu will appear when they are set to be on, whereas these menus will not appear when set to be off. In block B162, the information on the flip bar menu is reset as the need arises. For instance, the information about the user's past record and the information about what entries are registered in the Favorite Channels menu can be both reset.

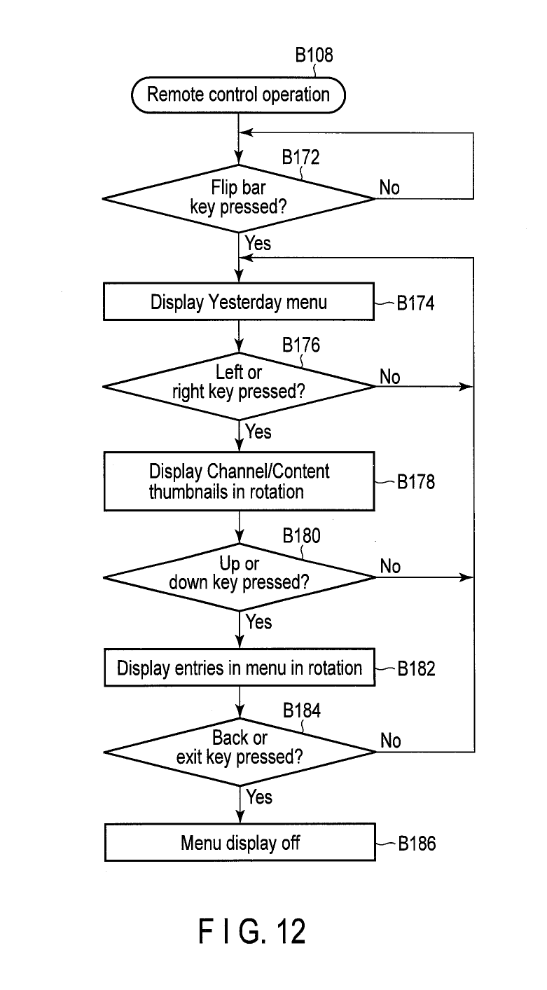

FIG. 12 is a flowchart illustrating an exemplified remote control operation in the embodiment. It is determined in block B172 whether or not the flip bar key is pressed. Let us assume here a condition that content is displayed on the screen but that no menu is displayed on the screen. When the flip bar key is pressed, the initial menu of the flip bar menu, for instance the Last Week menu, is displayed in block B174. Note that the sub-menu, which will be displayed when the flip bar key is pressed, is not limited to a predetermined initial menu but may be an immediately before displayed sub-menu.

It is determined in block B176 whether either one of the left key and the right key is pressed or not. When the left key or the right key is pressed, the focus moves leftward or rightward within the flip bar menu in block B178, which causes the displayed thumbnails to change in rotation. It is determined in block B180 whether either one of the up key and the down key is pressed or not. When the up key or the down key is pressed, the focus moves upward or downward within the flip bar menu in block B182, which causes the displayed sub-menus to change just as a drum rolls. It is determined in block B184 whether either one of the back key and the exit key is pressed or not. When the back key or the exit key is pressed, the initial menu disappears in block B186.

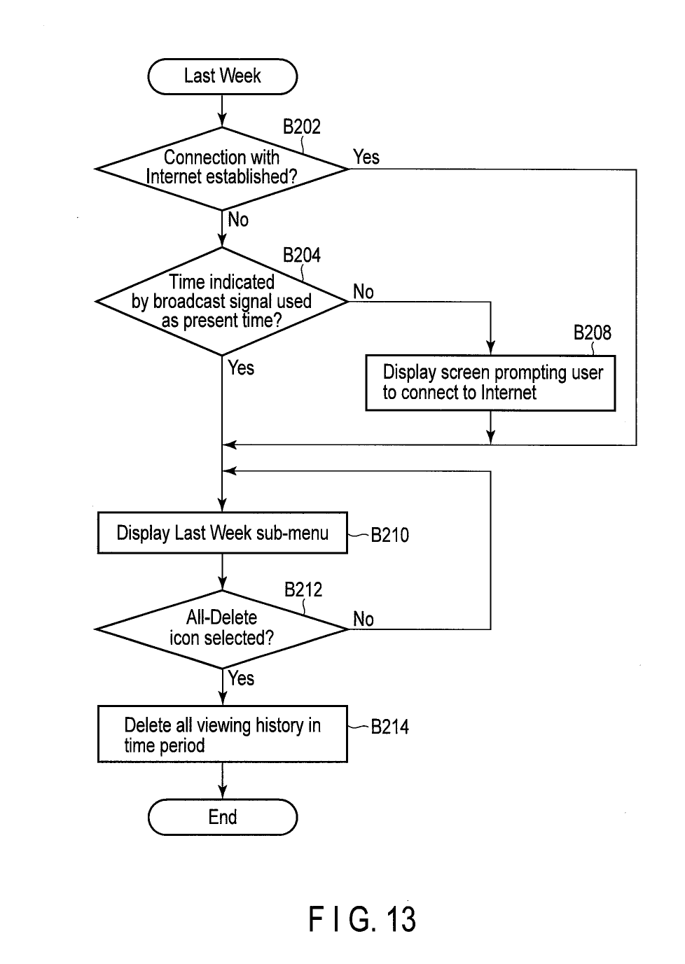

FIG. 13 is a flowchart illustrating how the exemplified Last Week menu is displayed in the embodiment. When the flip bar key is pressed, or when the Last Week sub-menu is selected by pressing either one of the up key and the down key on the remote controller while the flip bar menu is being displayed, it is determined in block B202 whether or not the connection with the Internet is established. If the connection is established, block B210 is advanced to. If the connection is not established, it is determined in block B204 whether or not a time indicated by a broadcasting station is set to be used as the present time. When the determination made in block B204 is a negative one, a screen prompting the user to connect with the Internet is displayed in block B208. The user is expected to make a connection with the Internet.

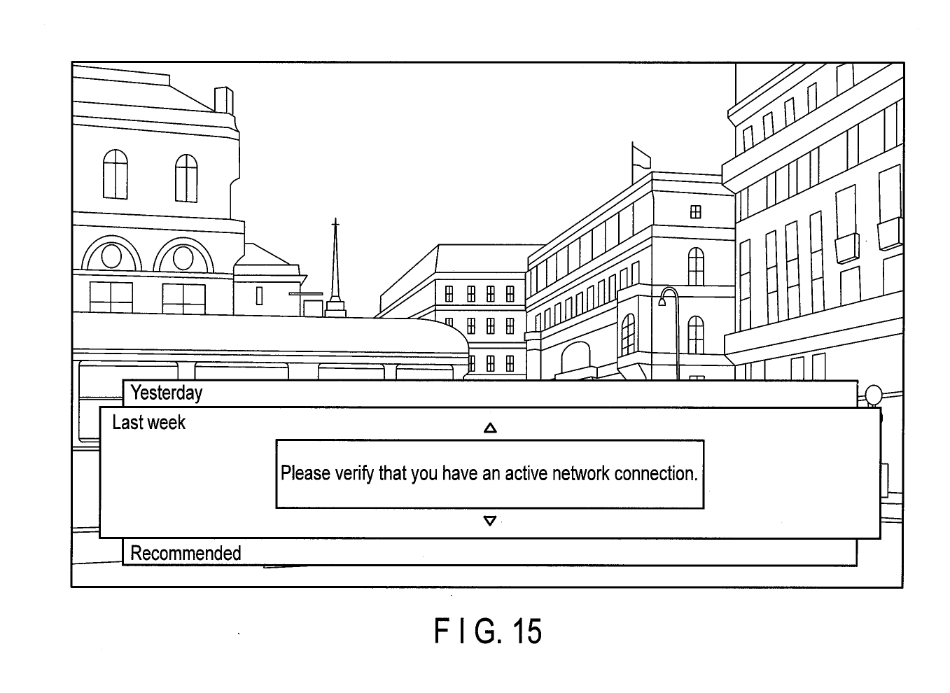

Following Yes in block B202 and Yes in block B204, and after block B208 (or after the present time has been obtained), the Last Week sub-menu, such as illustrated in FIG. 4 or FIG. 5, is displayed in block B210. The menu (the user's viewing history of a week ago) makes it possible for the user to easily find a program which the user wants to watch now. If the user wants to delete the viewing history, all that the user has to do is to press the right key 22 or the left key 26 at the remote controller, thereby causing the displayed 6 thumbnails to successively shift rightward or leftward and causing an all-delete icon to appear, and furthermore to select the all-delete icon while the all-delete icon is appearing and to press the OK key 36 (blocks B212 and B214). It should be noted that, when the reference channel is already set up, the initial activation of the Last Week sub-menu or the Yesterday sub-menu after the power is turned on causes to appear a screen prompting the user to select the reference channel (FIG. 14). When the reference channel is not yet set up, the initial activation of the Last Week sub-menu or the Yesterday sub-menu after the power is turned on causes to appear a screen (FIG. 15) prompting the user to connect to the Internet, such as illustrated in FIG. 15.

FIG. 16 illustrates an exemplified data structure of a viewing history in the embodiment. FIG. 16 illustrates a viewing history of one time period (30 minutes). A channel number, a channel name, a viewing start time, a total viewing time period, and a thumbnail are registered for every viewed program. In the example illustrated in FIG. 16, the user watched channel 5630-105 from 8:00 p.m., and then watched channel 0281-123 from 8:20 p.m. to 8:25 p.m. As described before, in order to avoid counting the channels zapped through as viewed, the viewing start time is set to be a time after 2 minutes has passed from a moment when the actual viewing has started, and an image displayed at such a moment is captured as a thumbnail. Therefore, the total of the viewing hours is 2 minutes shorter than the total of the actual viewing hours. When a certain single channel was viewed several times within the same single time period, the sum total of the viewing hours is calculated. The viewing history data of one week is preserved.

As having been explained above, a distinct window showing thumbnails indicative of the contents, which the user watched in the past, along with the information of the content will appear as being superposed on the contents presently displayed on the screen in the embodiment, which makes it possible for the user to reach the content, which the user may want to watch now, from the past viewing history within the fewest possible steps, resulting in permission for the user just passively seeing the television set to easily select the content, which the user want to watch. It is merely setting up not only the channel information on the internal tuner but also the channel information on the external tuner to be preserved that makes it possible to keep a viewing history of the externally input channels in addition to the viewing history of the internal channels, which allows the user to easily reach a program, which the user wants to watch, from a lot of channels. Since any programs will be shown along with their individual viewing start times and their individual pieces of channel information, even such programs, all of which the user watched within a much shorter time period, can be displayed along with their individual viewing start times and their individual pieces of channel information. Hitherto, there is a device that simply shows programs which are high in viewing frequency, but there is not a device that provides channel information of a program the user watched this time last week (or yesterday).

When the user presses the flip bar key while watching television, 10 pieces of information will appear along with their respective thumbnails for every category. The information includes a Favorite Channels item including programs which the user has previously registered, a Recently Viewed Channel item including programs which the user watched in the past, a Yesterday/Last Week item chronologically showing programs which the user watched in the past, or an Internet Contents/Recommended item recommended by the Internet based on the user's viewing history when connected with the Internet. Therefore, the user can reach the content, which the user wants to watch, just by making a selection from the groups of content.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

For instance, specific numerical values are not limited to the above-mentioned numerical values. Only a single time period that includes the present time may be shown at any sub-menu of the flip bar menu, such as the Yesterday/Last Week menu, for instance. The number that can be shown at a time nay be other than 6. The total number that can be shown at a time need not be 10. A single time period that includes the present time may be shown. Since the viewing history of one week is kept, the viewing history of several days before may be shown other than the viewing history of the previous day. Furthermore, all sub-menus except the Yesterday menu or the Last Week menu may be dispensed with. What should be displayed is such a piece of information that allows the user to see the channels, so that the thumbnails or the viewing start times need not be shown.

What is claimed is:

1. A display apparatus comprising a controller configured to display information relating to a content with the longest viewing time within a past predetermined time period.

2. The display apparatus of claim 1, further comprising:
a timer configured to measure a viewing time of a content from a point in time when a predetermined time has passed since the content has been displayed within the predetermined time period; and
a capture unit configured to capture an image form the content when the predetermined time has passed since the content has been displayed,
wherein the controller is configured to display the image captured from the content and information for specifying content.

3. The display apparatus of claim 2, wherein the controller is configured to prohibit an image of a parental control content being displayed.

4. The display apparatus of claim 2, wherein the information for specifying the program comprises at least one of a channel number, a channel name, and a point in time when a predetermined time has passed since the content has been displayed.

5. The display apparatus of claim 1, wherein the controller is configured to display the information on the content for a first time period comprising one of the present time of yesterday and the present time of last week and for at least one second time period closer to the present time than the first time period.

6. The display apparatus of claim 5, wherein the controller is configured to selectively display one of a first window and a second window, the first window is configured to present the information on the content for a first time period including the present time of yesterday and for at least one second time period closer to the present time than the first time period, and the second window is configured to present the information on the content for a third time period including the present time of last week and for at least one fourth time period closer to the present time than the third time period.

7. The display apparatus of claim 5, further comprising a display controller configured to display a screen configured to allow a user to select which broadcasting station's time to be used as the present time.

8. The display apparatus of claim 1, wherein the controller is configured to display an icon configured to delete all pieces of the information on the content.

9. The display apparatus of claim 1, further comprising a remote controller having a display key, wherein the controller is configured to display the information on the content based on a signal supplied from the display key when nothing is displayed except a content menu.

10. A display method comprising:
displaying information relating to a content with the longest viewing time within a past predetermined time period.

11. The display method of claim 10, further comprising:
measuring a viewing time of a content from a point in time when a predetermined time has passed since the content has been displayed within the predetermined time period;
capturing an image form the content when the predetermined time has passed since the content has been displayed; and
displaying the image captured from the content and information for specifying the content.

12. The display method of claim 10, wherein the information for specifying the program comprises at least one of a channel number, a channel name, and a point in time when a predetermined time has passed since the content has been displayed.

13. The display method of claim 10, wherein the displaying comprises displaying the information on the content for a first time period comprising one of the present time of yesterday and the present time of last week and for at least one second time period closer to the present time than the first time period.

14. The display method of claim 13, further comprising:
displaying a screen configured to allow a user to select which broadcasting station's time to be used as the present time.

15. A non-transitory computer-readable storage medium having stored thereon a computer program which is executable by a computer, the computer program comprising instructions capable of causing the computer to execute functions of:
displaying information relating to a content with the longest viewing time within a past predetermined time period.

16. The storage medium of claim 15, further comprising:
measuring a viewing time of a content from a point in time when a predetermined time has passed since the content has been displayed within the predetermined time period;
capturing an image form the content when the predetermined time has passed since the content has been displayed; and
displaying the image captured from the content and information for specifying the content.

17. The storage medium of claim 16, wherein the information for specifying the program includes at least one of a channel number, a channel name, and a point in time when a predetermined time has passed since the program has been displayed.

18. The storage medium of claim 15, wherein the displaying comprises displaying the information on the content for a first time period comprising one of the present time of yesterday and the present time of last week and for at least one second time period closer to the present time than the first time period.

19. The storage medium of claim 15, further comprising:
displaying a screen configured to allow a user to select which broadcasting station's time to be used as the present time.

20. The storage medium of claim 15, further comprising:
displaying an icon configured to delete all items of information on the content.
